(19) United States
(12) Patent Application Publication
(10) Pub. No.: US 2008/0048159 A1
(43) Pub. Date: Feb. 28, 2008

(54) Double-speed hydraulic bottle jack

(76) Inventors: Haoying Dai, Changshu (CN); Jiang Chen, Changshu (CN); Qiulin Wei, Changshu (CN)

Correspondence Address: LADAS & PARRY, 5670 WILSHIRE BOULEVARD, SUITE 2100, LOS ANGELES, CA, 90036-5679, US

(21) Appl. No.: 11/810,692

(22) Filed: Jun. 5, 2007

(30) Foreign Application Priority Data
Jul. 10, 2006 (CN) 200620075069.1

(51) Int. Cl. B66F 3/24

(52) U.S. Cl. 254/93 H

(57) ABSTRACT

A type of dual speed vertical hydraulic jack, including pedestal featuring hydraulic control pressure regulating assembly and oil drain valve assembly; jacket, hydraulic cylinder and pump body fixed on pedestal; oil storage cavity formed between jacket and hydraulic cylinder; piston rod with piston assembly at bottom; top cap, pump core, button, first oil path and second oil path; on bottom of said pump core, a step is provided and constitutes sealing with inner wall of pump cavity, third oil path and fourth oil path are provided on the step respectively, first steel ball valve and second steel ball valve that control connection and disconnection of said pump cavity with third oil path and fourth oil path respectively are provided on these oil paths, and at lower part of pump core, a fifth oil path is provided for connecting third oil path with upper cavity of pump cavity. Advantages: oil paths are simpler, as well as processing and assembling of parts, favoring higher efficiency; operating performance is stable and fault rate is low; and fast lifting at no load and slow driving under load are fully ensured, favoring increase of efficiency.

### FIELD OF THE INVENTION

This utility model is a hydraulic jack, in particular a dual speed vertical hydraulic jack with fast lifting at no load and slow driving under load.

### BACKGROUND OF THE INVENTION

Existing hydraulic jacks generally adopt single pump core hand pump to operate the pump core to suck oil and press hydraulic oil into operating cylinder. Disadvantage of this type of jack is: no matter how far is the top of piston rod from load, hydraulic oil is supplied to hydraulic cylinder cavity at the same amount of oil pressed (and sucked). For this reason, no matter what load on piston rod, lifting speed is the same, causing waste of time and low efficiency. Chinese Patent ZL93220041.9 discloses a type of dual speed manual vertical jack, Chinese Patent ZL01217506.4 discloses a type of dual speed hydraulic jack, and Chinese Patent ZL02263665.X discloses a type of dual speed hydraulic jack oil pump. Although these technologies aim to solve the problem of equal lifting speed at no load and under load at piston rod of single pump core manual hydraulic jacks, disadvantages exist to different degrees, e.g. complicated oil paths and structure etc. For example, in ZL93220041.9, a piston pair is added on existing jack piston rod. At no load, hydraulic oil sucked by pump core will first be pressed into piston rod inner cylinder via a one-way valve, so that piston rod can use small amount of hydraulic oil to generate fast displacement. In addition, by automatic supplementary oil supply by the one-way supplementary supply valve of the hydraulic cylinder outer cylinder, it is ensured that when the jack touches the load, the pump core will press hydraulic oil into outer cylinder via hydraulically controlled one-way valve as well, so that piston rod lifting speed will be slowed down. However, since the inner cylinder of this jack is installed in the operating cylinder where assembling and commissioning is difficult, structure of such jack is complicated, process performance is not satisfactory, operating performance is not stable, and fault rate is high.

### SUMMARY OF THE INVENTION

The task of this utility model is to provide a type of dual speed vertical hydraulic jack of simple oil path structure, easy processing and assembling, and fully ensured fast lifting at no load and slow driving under load.

Task of this utility model is fulfilled as follows: A type of dual speed vertical hydraulic jack, including pedestal 32 featuring hydraulic control pressure regulating assembly 20 and oil drain valve assembly 21; jacket 35, hydraulic cylinder 34 and pump body 17 fixed on pedestal 32 respectively; oil storage cavity 2 formed between jacket 35 and hydraulic cylinder 34; piston rod 1 placed in cavity 3 of hydraulic cylinder 34 and with piston assembly 36 at bottom; top cap 33 connected to top of jacket 35 and hydraulic cylinder 34 and used to support piston rod 1; pump core 18 fitted in pump cavity 8 of pump body 17; button 26 at top of pump core 18; and first oil path 5 (used to connect pump cavity 8 to cylinder cavity 3) and second oil path 6 (used to connect pump cavity 8 to oil storage cavity 2) provided on pedestal 32; characterized by that on bottom of said pump core 18, a step 38 is provided and constitutes sealing with inner wall of pump cavity 8, third oil path 9 and fourth oil path 12 are provided on step 38 respectively, first steel ball valve 15 and second steel ball valve 11 that control connection and disconnection of said pump cavity 8 with third oil path 9 and fourth oil path 12 respectively are provided on these oil paths (9 and 12), and at lower part of pump core 18, a fifth oil path 14 is provided for connecting third oil path 9 with upper cavity of pump cavity 8.

Said third oil path 9 and fourth oil path 12 of this utility model are provided on step 38 longitudinally and in parallel to each other.

Said third oil path 9 of this utility model is provided on step 38 corresponding to center of pump core 18.

At lower part of said pump core 18 of this utility model, pump core concave cavity 13 corresponding to the said third oil path 9 and connecting to fifth oil path 14 is provided, and this cavity 13 includes first spring 16, which is in contact with first steel ball valve 15.

Inside said fourth oil path 12 of this utility model, second spring 10 is provided, and in contact with second steel ball valve 11.

Compared with existing technologies, advantages of this utility model are: First, oil paths are simpler, as well as processing and assembling of parts, favoring higher efficiency; Second, operating performance is stable and fault rate is low; Third, fast lifting at no load and slow driving under load are fully ensured, favoring increase of efficiency.

### BRIEF DESCRIPTION OF THE DRAWINGS

FIG. 1 is sectional view of this utility model.

FIG. 2 is spatial structural view of this utility model.

FIG. 3 is the cutaway view of hydraulically controlled pressure regulating assembly 20 on pedestal 32 of this utility model.

FIG. 4 is the cutaway view of oil drain valve assembly 21 on pedestal 32 of this utility model.

In which: 1. Piston rod; 2. Oil storage cavity; 3. Cylinder cavity; 4. Third steel ball valve; 5. First oil path; 6. Second oil path; 7. Fourth steel ball valve; 8. Pump cavity; 9. Third oil path; 10. Second spring; 11. Second steel ball valve; 12. Fourth oil path; 13. Pump core concave cavity; 14. Fifth oil path; 15. First steel ball valve; 16. First spring; 17. Pump body; 18. Pump core; 19. Handle; 20. Hydraulically controlled pressure regulating assembly; 21. Oil drain valve assembly; 22. Pin shaft; 23. Connecting rod; 24. Pin shaft; 25. Pin shaft; 26. Button; 27. Sixth oil path; 28. Fifth steel ball valve; 29. Seventh oil path; 30. Sixth steel ball valve; 31. Eighth oil path; 32. Pedestal; 33. Top cap; 34. Hydraulic cylinder; 35. Jacket; 36. Piston assembly; 37. Sealing gasket; 38. Step.

### DESCRIPTION OF THE PREFERRED EMBODIMENT

Applicant's description of preferred embodiment below will help understand technical essence and effect of this utility model. However, the preferred embodiment will not constitute any limit on the technical scheme of this invention.

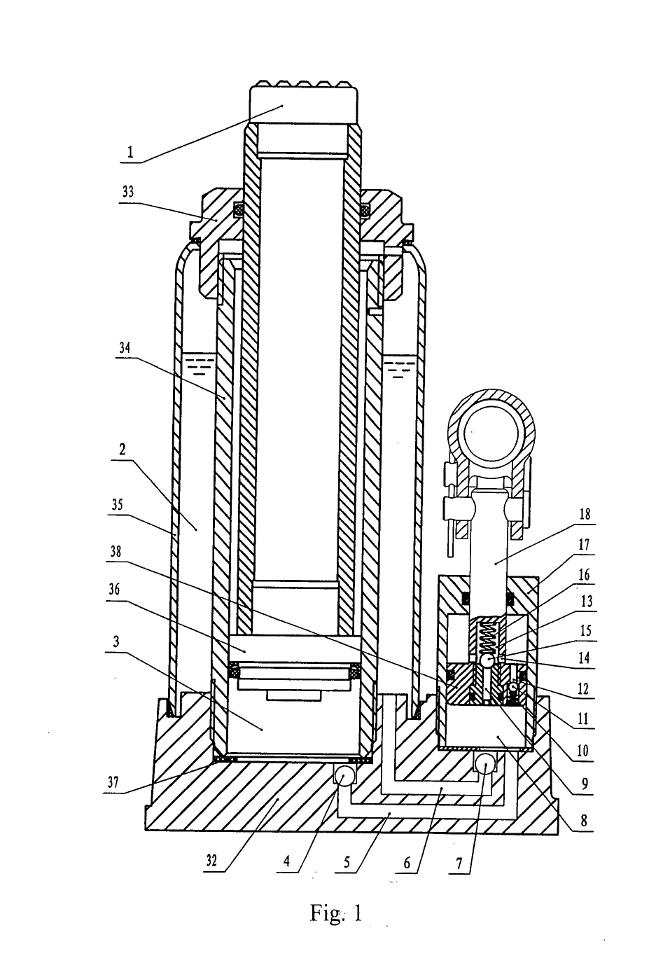

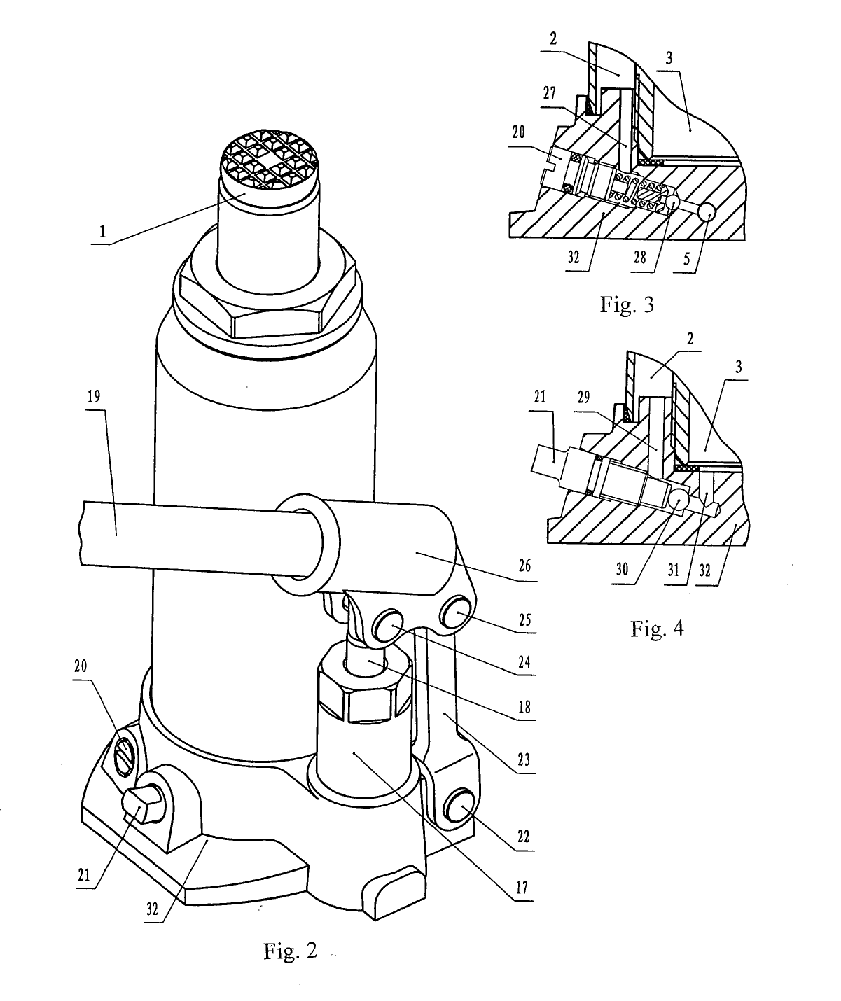

Referring to FIG. 1 and in combination with FIG. 2, FIG. 3 and FIG. 4, bottom of said hydraulic cylinder 34 of this utility model is connected to pedestal 32 via screw thread pair and sealing gasket 37. Top part is screwed on top cap assembly 33 via screw thread pair. Jacket 35 is put on hydraulic cylinder 34 (at outside), its bottom constitute sealed connection via corner seal and pedestal 32, and its top part constitute sealed connection with top cap 33. Oil storage cavity 2 is formed between inner circle of jacket 35 and outer circle of hydraulic cylinder 34. Top end of piston rod 1 threads through central hole on top cap 33 to reach upper part of top cap 33, and its bottom end is placed in cylinder cavity 3 of hydraulic cylinder 34. At this bottom end, piston assembly 36 is provided and closely matches cavity wall of cylinder cavity 3 of piston assembly. Cylinder cavity 3 under piston assembly 36 constitutes operating cylinder cavity, and piston rod 1 matches central hole on top cap assembly 33 to form movement sealing. Bottom end of pump body 17 is connected to pedestal 32 via screw thread pair and sealing gasket. A central hole is provided on middle of top part. Lower end of pump core 18 is inside pump cavity 8 of pump body 17 and step 38 is provided at bottom part. Outer circle of step 38 closely matches cavity wall of pump cavity 8 of pump body 17. Step 38 divides pump cavity 8 of pump body 17 into upper and lower cavities. Longitudinally on step 38, third oil path 9 and fourth oil path 12 are provided in parallel. On these oil paths, first steel ball valve 15 and second steel ball valve 11 controlling connection and disconnection of third oil path 9 and fourth oil path 12 with upper and lower cavities of said pump cavity 8 are provided. At lower part of pump core 18, the fifth oil path 14 is provided for connecting third oil path 9 to pump cavity 8. Third oil path 9 is provided on step 38 corresponding to center of pump core 18. Inside pump core 18 corresponding to third oil path 9, pump core concave cavity 13 connected to fifth oil path 14 is provided. Inside cavity 13, first spring 16 is installed and in contact with first steel ball valve 15. Fourth oil path 12 is provided on step 38 corresponding to one side of center of pump core 18, inside which second spring 10 is provided and in contact with second steel ball valve 11. Upper end of pump core 18 penetrates central hole on pump body 17 top end, and then extends outside pump body 17 and is connected to button 26 via pin shaft 24. At one end of button 26, handle 19 is installed, and at the other end, it is hinged with one end of connecting rod 23 via pin shaft 25. The other end of connecting rod 23 is connected to pedestal 32 via pin shaft 22. On said pedestal 32 of this utility model, first oil path 5 and second oil path 6 are provided. One end of first oil path 5 is connected to the operating cylinder cavity 3, and the other end is connected to pump cavity 8. One end of second oil path 6 is connected to oil storage cavity 2, and the other end is connected to pump cavity 8. In addition, on oil paths 5 and 6, third steel ball valve 4 and fourth steel ball valve 7 controlling connection and disconnection of oil path are provided respectively. On oil path 5 of this utility model connecting to pump cavity 8, hydraulically controlled pressure regulating assembly 20 (connected to pedestal 32 by threads) is provided at step hole on sixth oil path 27 connecting oil storage cavity 2. One end of this assembly can be tightened and loosened with fifth steel ball valve 28 by screw thread pair, to realize closing and opening of fifth steel ball valve 28 at opening of first oil path 5, and hence providing overload protection for the hydraulic system. On the eighth oil path 31 of this utility model connecting to operating cylinder cavity of cylinder cavity 3, oil drain valve assembly 21 (connected to pedestal 32 via thread) is provided at step hole on seventh oil path 29 connecting oil storage cavity 2. One end of this assembly can be tightened and loosened with sixth steel ball valve 30 via screw thread pair, to realize closing and opening of sixth steel ball valve 30 at opening of the eighth oil path 31, and hence unloading oil drain of hydraulic system.

This utility operates as follows: With the jack under light load or at no load, raise handle 19 to drive button 26 to rotate upward round pin shaft 25. Pump core 18 is connected to button 26 via pin shaft 24. Since pin shaft 25 can rotate about pin shaft 22 along with connecting rod, pump core 18 can move upward vertically. While pump core 18 moves up and sucks oil, hydraulic oil in oil storage cavity 2 will flow past second oil path 6, open fourth steel ball valve 7, and enter lower cavity of pump cavity 8 of pump body 17. At the same time, hydraulic oil in pump cavity 8 upper cavity will flow pass fourth oil path 12 and after overcoming pressure of second spring 10, open second steel ball valve 11 to enter lower cavity of pump cavity 8. When handle 19 is pressed down, button 26 will be driven for downward rotation around pin shaft 25, and pump core 18 will be driven down vertically. With the jack under light load or at no load, pressure of hydraulic oil in lower cavity of pump cavity 8, and it is not possible to overcome pressure of first spring 16. Therefore, first steel ball valve 15 cannot be opened and the two lines of hydraulic oil in lower cavity of pump cavity 8 jointly pass first oil path 5, open third steel ball valve 4, and then flow into operating cylinder cavity of cylinder cavity 3. Larger oil supply will cause fast movement of piston rod 1. When the jack touches the load, pressure of hydraulic oil in lower cavity of pump cavity 8 is relatively high, sufficient to overcome pressure of first spring 16 so that first steel ball valve 15 will automatically open, and hydraulic oil in lower cavity of pump cavity 8 will pass third oil path 9 and fifth oil path 14 to overflow into upper cavity of pump cavity 8. Since ring sectional area of upper cavity of pump cavity 8 is slightly smaller than cross sectional area of lower cavity of pump cavity 8, at this time, in addition to diversion and overflow into upper cavity of pump cavity 8, a small part of hydraulic oil in lower cavity of pump cavity 8 will pass first oil path 5, open third steel ball valve 4, and then continue to be supplied to operating cylinder cavity of cylinder cavity 3. Smaller oil supply results in slow movement of piston rod 1. Therefore, when jacking heavy object, piston rod 1 can slowly and stably rise, thereby realizing the effect of high pressure and slow pumping. In this hydraulic system, when load exceeds rated load, oil pressure will exceed the pressure in first oil path set by hydraulically controlled pressure regulating assembly 20, so that in addition to diversion and overflow into upper cavity of pump cavity 8, another part of hydraulic oil pressed out of lower cavity of pump cavity 8 will pass first oil path 5, open fifth steel ball valve 28 at one end of hydraulically controlled pressure regulating assembly 20, and then pass sixth oil path 27 to return to oil storage cavity 2, thereby realizing self overload protection of the system.

When the jack completes its operation, slowly loosen oil drain valve assembly 21 so that sixth steel ball valve 30 is loose. At this time, hydraulic oil in cylinder cavity 3 operating cylinder cavity will pass the eighth oil path 31 and seventh oil path 29 to return to oil storage cavity 2, thereby realizing unloading oil drain of hydraulic system. When this oil drain valve assembly 21 is tightened, the sixth steel ball valve 30 will push tightly and close, thereby realizing pressure maintaining of hydraulic system.

What is claimed is:

1. A type of dual speed vertical hydraulic jack, including pedestal (32) featuring hydraulic control pressure regulating assembly (20) and oil drain valve assembly (21); jacket (35), hydraulic cylinder (34) and pump body (17) fixed on pedestal (32) respectively; oil storage cavity (2) formed between jacket (35) and hydraulic cylinder (34); piston rod (1) placed in cavity (3) of hydraulic cylinder (34) and with piston assembly (36) at bottom; top cap (33) connected to top of jacket (35) and hydraulic cylinder (34) and used to support piston rod (1); pump core (18) fitted in pump cavity (8) of pump body (17); button (26) at top of pump core (18); and first oil path (5) (used to connect pump cavity (8) to cylinder cavity (3)) and second oil path (6) (used to connect pump cavity (8) to oil storage cavity (2)) provided on pedestal (32); characterized by that on bottom of said pump core (18), a step (38) is provided and constitutes sealing with inner wall of pump cavity (8), third oil path (9) and fourth oil path (12) are provided on step (38) respectively, first steel ball valve (15) and second steel ball valve (11) that control connection and disconnection of said pump cavity (8) with third oil path (9) and fourth oil path (12) respectively are provided on these oil paths ((9) and (12)), and at lower part of pump core (18), a fifth oil path (14) is provided for connecting third oil path (9) with upper cavity of pump cavity (8).

2. A dual speed vertical hydraulic jack as described in claim 1, characterized by that the said third oil path (9) and fourth oil path (12) are provided on step (38) longitudinally and in parallel to each other.

3. A dual speed vertical hydraulic jack as described in claim 1, characterized by that the said third oil path (9) is provided on step (38) corresponding to center of pump core (18).

4. A dual speed vertical hydraulic jack as described in claim 1, characterized by that at lower part of said pump core (18), pump core concave cavity (13) corresponding to said third oil path (9) and connecting to fifth oil path (14) is provided, and this cavity (13) includes first spring (16), which is in contact with first steel ball valve (15).

5. A dual speed vertical hydraulic jack as described in claim 1, characterized by that inside said fourth oil path (12), second spring (10) is provided, and in contact with second steel ball valve (11).
